(19) United States
(12) Patent Application Publication
(10) Pub. No.: US 2009/0031426 A1
(43) Pub. Date: Jan. 29, 2009

(54) Method and System for Protected Distribution of Digitalized Sensitive Information

(76) Inventors: Stefano Dal Lago, Torino (IT); Giuseppe Mazara, Torino (IT); Benedetto Riolfo, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/087,219

(22) PCT Filed: Dec. 30, 2005
(86) PCT No.: PCT/EP2005/014129

§ 371 Date: Oct. 2, 2008

(51) Int. Cl. G06F 21/00; H04L 9/00

(52) U.S. Cl. 726/26; 713/150

(57) ABSTRACT

A method of protecting sensitive information in an information exchange between a first data processing system suitable to supply sensitive information and a second data processing system suitable to use sensitive information includes: selecting in the first data processing system a sub-set of sensitive information elements from a collection of digital sensitive information elements; storing the selected sub-set of sensitive information elements in a responsive software agent suitable to automatically react to information queries; submitting the responsive software agent to an information query generated by the second data processing system; and reacting or responding to the information query by the software agent based on the sub-set of sensitive information. The responsive software agent is advantageously generated in the first data processing system and transferred to the second data processing system to locally respond to the queries.

### BACKGROUND OF THE INVENTION

1. Field of the Invention

The present invention relates generally to management of information in digital form and regarding individuals or organizations (e.g., businesses), and in particular to the protection of said information against uses not authorized by the legitimate information owners whenever the information is distributed, i.e. transferred to third parties.

2. Description of Related Art

Information about persons, companies, organizations and public institutions has been a sensitive and valuable asset in many areas of social importance for a long time. As regards trade, for instance, it has ever been relevant for companies and commercial organizations to gain knowledge about their customers' behaviors, preferences, attitudes, choices, as well as to become aware of their competitors' strategies and plans. More generally, many mechanisms at the basis of organized societies rely on the possibility for public and private institutions to attain a certain degree of understanding of tastes, preferences and habits of populations and individuals, citizens or consumers.

In turn, individuals or groups of individuals have often an interest in making a controlled amount of information about themselves available to third parties, for instance because, by doing so, they can obtain products/services that are better suited to their needs.

Overall, it can be said that information about people has frequently been treated as a particular type of goods among many others, with demand/offering dynamics, supplier-consumer interactions and, above all, a balance to be achieved across different trading situations.

A normal way to attain a balance between information demand and information offering is negotiation between an information supplier and an information consumer, where the information consumer usually declares the type and amount of the needed information and the purpose of the information request, while the information supplier decides what pieces of his/her own information he/she would like to release after consideration of the stated purpose. For example, a public utility may request a user's postal address in order to be able to deliver a bill; a shopkeeper may ask for information about a customer's preferences in order to be able to provide advices about a product; a corporation may investigate a candidate employee's attitudes and skills; a bank may inquiry a customer about his/her economic assets in order to suggest a form of investment, and so on.

A risk inherent in any information trade resides in the possibility of misuse of the released information.

Misuses can in particular be expected in the event that the provided information does not arrive only at the intended information consumer, but also reaches, or is intercepted by unauthorized third parties. A well-known method of addressing this concern consists in making information unusable by third parties, or usable only at a high cost, for instance by means of cryptographic techniques that imply binding the exchanged information to a secret and sharing the secret only between the information supplier and the intended recipient.

Another risk is that the information consumer uses the acquired pieces of information in a different way, or for a different purpose than agreed with the information supplier. In fact, information is at the same time something the supplier would like to give away in exchange of some benefits, and something he/she is concerned with disclosing. This is particularly true for certain types of information that include sensitive data (like data concerning the state of health, or the religion, or the politics), because in this case a greater damage may derive to the information supplier from the consequences of information misuse. In other words, an information consumer is at the same time someone whom information has to be delivered to, and someone whom information must be protected from. This is an intrinsic contradiction of any information exchange mechanism, clearly more of importance when there is no a priori trust relationship between the information supplier and the information consumer. The effects of such contradiction cannot be eliminated but only mitigated, for instance by decreasing the amount of transferred information to the very minimum that is needed to optimize a transaction between the information supplier and the information consumer, or by placing and enforcing legal boundaries that restrict the possibilities of information misuse by the information consumer.

Specific issues are raised by dissemination of information in digital form. In this case, information misuses can be implemented in an easier way and cause a more severe damage to the information supplier. In fact, digitized information can be transferred to unauthorized third parties at far higher rates; moreover, digitized information processing can be automated, thus multiplying the effects of unintended uses. For instance, an individual's credit card number can be instantly made available worldwide through a computer network; or, a customer's e-mail address can be inserted into spamming engines that deliver several undesired messages per day.

In the art, information management issues have been addressed more than sensitive information security.

For example, various methods for managing a customer's Network Identity (NI) can be found in the literature or in commercial products, aiming essentially at relieving the information supplier from the burden of repeatedly providing similar information to several information consumers. Typically, the information supplier is requested to create different accounts within different service provider domains in order to get access to value added services: the information supplier is often requested to disclose the same information and personal data to various service providers. The information supplier is responsible for remembering multiple username/password pairs for each identity and for managing every single account to ensure it is up-to-date and appropriate: usually, the information supplier tends to use the same username/password everywhere, or to record account data on non-protected media: in both cases the result is a drop in the security level. In general, there is a loss of control over sensitive information when disclosed to service providers.

Proposed solutions to the management of personal information are in general based on the basic concept of introducing a third party, intermediating between the information supplier and the information consumer, who is responsible for managing sensitive data. Data security is entirely delegated to said third party and its effectiveness depends on how much said third party can be trusted upon, since the information supplier has no technical means of staying in control of his/her information after it has been released.

Some solutions known in the art include systems that force an information supplier to entirely rely on the information consumer as regards the security of his/her sensitive data. The information supplier has no technical way of controlling the use that is made of such data after the information has entered an information consumer domain. An example of said systems is the Microsoft Passport software platform (a description thereof is for example available at the Internet site http://msdn.microsoft.com/library/default.asp∵url=/library/en-us/passport25/start full.asp), which enables its users to access a plurality of services by injecting into the platform personal identification data. Without entering into excessive details, known to those skilled in the art, Passport is a core component of the Microsoft “.NET” platform, and is possibly the most developed identity service so far: since the Passport system was initiated in 1999, more than 200 million accounts have been set up worldwide at today. It enables businesses to develop and offer distributed web services across a wide range of applications and allows its members to use one sign-in name and password at all participating web sites, in exchange for supplying Microsoft with personal details such as name, occupation and ZIP code. When a user registers a Passport account he/she has to determine the shared profile information, then a Passport User ID (PUID) is assigned to the account, which PUID becomes the user's unique identifier. The PUID is a 64-bit number that will be sent (encrypted with 3DES algorithm) to the Passport Service Provider site as the authentication credential when a Passport user signs in. During the signing in process, the user is re-directed to a web site within the Microsoft .NET server domain, where he/she has to enter name and password. The .NET server attaches two cookies to the browser and returns it to the originating site: the first one contains the authentication ticket information, the second one contains any profile information the user has chosen to share, and any operational information and unique identifiers that need to be passed. It's up to the user to decide whether to share sensitive data with the service provider.

Although Passport represents one of the milestone of Microsoft vision of “Trustworthy Computing” (that includes also the Palladium Project and the Microsoft Digital Rights Management platform), it keeps raising many questions related both to security aspects and to the Microsoft users' profile retention policy. Passport showed up severe security flaws allowing the attackers to take control of the other users' account, to use their authentication data and their Hotmail mailboxes, and also to steal their sensitive data. On the other side, users are concerned about potential misuse of their profile data: Microsoft declares to retain, for “customer service” purposes, information related to the users and the web sites visited for some period of time but, on the other side, the users have no possibility to verify how the personal profile is actually used.

Other known solutions include infrastructures that grant an information supplier a certain degree of control over his/her sensitive data even after said sensitive data have been delivered to information consumers. This is achieved for instance by requiring an explicit authorization from the information supplier each time a piece of sensitive data is exchanged between two or more information consumers.

An example of such behavior is provided by the Liberty Alliance software platform. The Liberty Alliance Project is an alliance of more than 150 companies, non-profit and government organizations, and is committed to developing an open standard for federated network identity that supports all current and emerging network devices.

The Identity Federation (or Account Linkage) concept is related to the so called Simplified Sign On (SSO) procedure, by means of which a service provider or identity provider may signal to another service provider or identity provider that the user is in fact authenticated. Because of the existing trust relationship between the identity provider and the service provider (likely in the form of both business agreements and cryptographic mechanisms), the latter is willing to grant access to its resources based on the previous authentication operation performed at the first identity provider. In summary, SSO enables users to sign on once with a member of a federated group of identity and service providers, and subsequently use various websites among the group without having to sign on again. Furthermore, the Liberty Alliance framework ensures user data to be released only with the user consent and in accordance with user's defined policies: in such a way the information consumer is able to maintain a certain degree of control over his/her own profile, but is forced to disclose it to an identity provider who is responsible for managing sensitive information on his/her behalf. Service providers using the Liberty Alliance platform can obtain and share users authentication data, and store other pieces of sensitive customer information in their own data bases: for example, a bank may hold information about a customer's ability to pay a certain amount of money, while an on-line shop may know about the customer's preferences concerning a certain type of product. The bank and the on-line shop may independently use the portion of customer information they got in accordance to the purposes for which it was granted to them. However, the customer can be requested by the Liberty Alliance platform to clear any transfer of said sensitive data between the two businesses, for instance in the event that the shop requires the bank to check whether the customer is able to pay for a certain product.

EP 1 379 045 discloses an arrangement and a method for protection of end user personal profile data in a communication system comprising a number of end user stations and a number of service/information/content providers or holding means holding end user personal profile data. An intermediate proxy server supports a first communication protocol for end user station communication and comprises means for providing published certificates; a personal profile data protection server supports a second communication protocol for communication with the intermediate proxy server and a third communication protocol for communication with a service/information/content provider, and an Application Programming Interface (API) allowing queries/interactions by the service/information/content provider, and comprises storing means for storing end user specific data and end user personal profile data. The intermediary proxy server comprises means for verifying the genuinity of a certificate requested over the second communication protocol from the personal profile protection server against a published certificate. The service/information/content server can request, via the API, personal profile data, which are delivered according to the end user preferences or in such a manner that there is no association between the actual end user and the personal profile data thereof.

In the context of the JADE (where JADE stands for “Java Agent DEvelopment framework”, which is a software framework, described for example at http://jade.tilab.com/, fully implemented in Java language that simplifies the implementation of multi-agent systems through a middle-ware that complies with the FIPA—Foundation for Intelligent Physical Agents), the concept of flying profile has been developed; as described for example in WO 2004/077784, in a method and system for providing information services to a client using a user profile, a flying profile manager is provided, on the client side, responsible for the selection of a portion of a user model to be sent to an information service server and for the negotiation process of sensible data between the client and the server. For example, if the server needs a specific item of information about the user, like the age, the flying profile manager replies only if the user agrees (either as a direct reaction of the user to a request presented on his/her terminal, or by means of a suitably programmed software user agent). The transferred amount of information is regarded as of a temporary type, meaning that an agreement between the information supplier and consumer obliges the latter to eliminate said information amount (e.g. by deleting any relevant record in a data base) immediately after it has been used for the intended purposes.

### SUMMARY OF THE INVENTION

The Applicant has observed that prior-art solutions for acquiring and managing sensitive information in digital form either do not address the information misuse issue as a whole, or said issue is only partially solved.

In particular, none of the known solutions protects the information provided by the information supplier after the information has been sent to the information consumer.

For example, the Microsoft Passport platform simply collects information provided by individuals and stores it into centralized facilities (data centers), releasing (parts of) said information to service providers (i.e. information consumers) that have adopted the Passport technology, all without user intervention.

In the Liberty Alliance identity system the user is forced to disclose personal information to the identity provider, which is responsible for managing the sensitive information on the user's behalf.

In EP 1 379 045, the presence of the proxy function does not avoid the releasing of sensitive information in plaintext to information consumers: it simply filters the amount of information to be released according to general criteria defined by the information supplier, e.g. the desired privacy level to be attained. Also, there is no means for the information supplier to stay in control of the personal profile once the information is in the information consumer domain, nor to set and enforce strict usage limitations to avoid information misuse.

Concerning the flying profile concept, the Applicant observes that also in that case personal information is released, although the pieces of information released are a subset of the user model and expire after use.

The Applicant has observed that in face-to-face, human-to-human negotiations between a human information supplier and a human information consumer, the information supplier usually provides the least possible amount of information that is needed to optimize a transaction with the information consumer: for example, a customer visiting a shop needs does not need to provide the shopkeeper with details about his/her tastes and preferences, he/she can simply browse a catalogue or move around the shop shelves and pick up what he/she likes most. In certain cases, the amount of information to be transferred can even be reduced to zero: for instance, a bank customer who happens to be physically present at the bank premises does not need to provide any information about his/her postal address in order to receive a bank report: the document can simply be taken away by the customer.

The Applicant has observed that such a pattern is normally not followed whenever the human information supplier and/or the human information consumer are not physically in touch with one another: for example, a bank customer cannot be at the bank office all the time, therefore he/she needs to provide the bank with information like his/her postal address, telephone number or the equivalent in order to receive communications from the bank; a shop customer may not have much time to devote to personally visiting a book shop, and he/she may find convenient to tell the shopkeeper about his/her personal preference, so that the shopkeeper can quickly find out the most suitable products. In other words, the fact that a human information supplier is often forced to delegate, or even to abstain from certain phases of the information trading process may lead to an otherwise unnecessary release of valuable information which, once provided, can hardly be withdrawn or controlled by the information supplier.

The Applicant has tackled the problem of how to effectively protect digitized sensitive information, i.e. information describing sensitive properties of individuals and/or organizations expressed in digital form.

In particular, the Applicant has tackled the problem of how to ensure that once said information has been disseminated, transferred to an information consumer, its use can nonetheless be restricted within boundaries set by the legitimate information owner, and for example not be provided to third parties without authorization.

The Applicant has observed that in order to effectively avoid or at least limit misuse of digitized sensitive information, protection of the sensitive information needs to continue after the data embedding the sensitive information have been transferred into an information consumer domain, for instance by requiring an authorization from the legitimate information owner each time said data are to be used. The Applicant has thus tackled the problem of devising a persistent data protection mechanism specifically adapted to protecting digitized sensitive information.

In particular, the Applicant has found that the sought persistent data protection mechanism can be implemented by exploiting well-known concepts of Digital Rights Management (DRM) systems, typically used to protect digital media content, like digitized movies, music, etc., at the same time making the media content available to a content consumer for use, and protecting it against possible misuses. In particular, DRM systems exploit encryption of the digital media items, and associated digital licenses, which can contain digitized usage rules (e.g., predetermined time and/or territorial boundaries) set by the legitimate content owner and an associated cryptographic key to decrypt the digital media item.

The Applicant has however observed that digitized sensitive information has specificities that make a straightforward application of DRM techniques thereto not useful to ensure persistent protection of the information after distribution to information consumers.

Indeed, DRM systems aim at making an illegal duplication of a protected digital media item so disadvantageous for the content consumer to discourage him/her (although it is practically impossible to absolutely prevent an illegal duplication while a media item is used, e.g. listened or watched to). For example, the analog output signal of a player playing a protected digitized video could be recorded by means of a Video Cassette Recorder (VCR), but techniques (like the known Macrovision system) adapted to deliberately deteriorate the quality of the copied signal make the illegal duplicate practically unusable by the occasional content pirate, normally not equipped with professional signal restoration tools. As another example, a digital video player can insert a digital watermark into its output signal in order to bind it to the legitimate content consumer identity, which allows the owner of the content tracking an illegal distribution of the copies and prosecute the content consumer. In general, all the available technological countermeasures against illegal duplication and dissemination of digital media content can still be circumvented, but only at a certain cost, depending on the specific measure, and this cost is expected to discourage most of the content consumers.

Differently from digital media, digitized sensitive information, describing properties of individual or organizations, is typically expressed in textual form. Textual information can be easily copied substantially without undesirable side effects (like quality degradation) the first time it is accessed. Thus, due to its nature of being susceptible of expression in textual form, even if digitized sensitive information is enclosed within a protected container (e.g., by encrypting it), a possibly perfect, unidentifiable copy of it can be simply, even manually taken out of the container and stored somewhere else during the legitimate, authorized information reading process.

The Applicant has found that data representing digitized sensitive information to be given to an information consumer can be persistently protected by embedding the digitized sensitive information into a digitally protected software object, hereinafter also referred to as a Protective Responsive OBject (PROB), adapted to emulate human behavior in information trading, so as to extend to automated processing of digitized sensitive information the interaction pattern that normally applies when face-to-face negotiation between a human information supplier and a (human) information consumer takes place.

In the context of the present invention, a software object is to be considered as equivalent to a software agent (or autonomous agent or intelligent agent), which is generally intended as a computer program working in a dynamic environment on behalf of another entity (human or computational), possibly over an extended period of time, without continuous direct supervision or control, and able to emulating a human behavior in the interaction with other (particularly software) entities.

The digitally protected software object, for example a software agent, represents, i.e. acts on behalf (as a proxy) of, the corresponding information supplier (an individual or an organization) in transactions with an information consumer that he/she cannot physically take part in. The digitally protected software object is an active entity that not only contains information about the information supplier, but is also adapted to infer from said information how the human information supplier would act in certain situations, and, in an interaction with an information consumer in the context of an automated trading of sensitive information, to release the minimum possible amount of information needed to optimize a transaction.

Thanks to the fact that the software object is not merely a repository of information, i.e. it does not make available information in textual form, the digital protection thereof is adapted to be secured for example exploiting concepts derived from DRM systems. In this way, it is possible to restrict the possibility of interacting with the digitally protected software object to information consumers that have preliminary been authorized by the human information supplier, so as to avoid unintended dissemination of information.

According to a first aspect thereof, the present invention relates to a method of protecting sensitive information in an information exchange between a first data processing system suitable to supply sensitive information and a second data processing system suitable to use sensitive information, comprising:

selecting in the first data processing system a sub-set of sensitive information elements from a collection of digital sensitive information elements;
storing the selected sub-set of sensitive information elements into a responsive software agent suitable to automatically resact to information queries;
submitting the responsive software agent to an information query generated by the second data processing system; and
reacting to the information query by the software agent based on the sub-set of sensitive information.

Preferably, the method further comprises generating the software agent in the first data processing system.

The step of submitting may be performed in the first data processing system and it may be preceded by the step of sending the query from the second data processing system to the first data processing system.

Alternatively, the step of submitting may be performed in the second data processing system and it may be preceded by the step of transferring the software agent from the first to the second data processing system.

The software agent is preferably transmitted over a data communication network.

The step of transferring the software agent may comprise protecting the software agent from unauthorized access to the sub-set of sensitive information.

The step of protecting may comprise encrypting the software agent and providing the second data processing system with a decryption key for decrypting the software agent.

The decryption key may be a symmetric encryption/decryption key.

Providing the second data processing system with a decryption key may comprise:
encrypting the symmetric decryption key with a public encryption key of the second data processing system;
transferring the encrypted symmetric decryption key to the second data processing system over the data communication network.

The method may further comprise generating a digital license comprising usage rules of the sub-set of sensitive information, in the first data processing system.

Moreover, the method preferably comprises sending the digital license from the first to the second data processing system.

The digital license may include the symmetric encryption/decryption key and the method may further include encrypting the digital license with the public encryption key of the information consumer.

The method may further comprise:
receiving the encrypted digital license at the second data processing system;
decrypting the encrypted digital license to extract the symmetric encryption/decryption key;
decrypting the software agent;
installing the software agent in the second data processing system.

The usage rules may comprise a usage time limit.

The method may further comprise, after submitting the responsive software agent to an information query, requesting additional information from the software agent to a further software agent.

Moreover, the method may comprise, after submitting the responsive software agent to an information query, requesting additional information from the software agent to the first data processing system.

Reacting to the information query may comprise responding to the information query based on the sub-set of sensitive information. Moreover, reacting to the information query may comprise responding to the information query based on the additional information.

### BRIEF DESCRIPTION OF THE DRAWINGS

The features and advantages of the present invention will be made apparent by the following detailed description of some embodiments thereof, provided merely by way of non-limitative examples, description that will be conducted making reference to the annexed drawings, wherein:

FIG. 1 pictorially shows a scenario wherein an embodiment of the invention is applied;

FIG. 2 schematically shows a structure of a generic data processing apparatus;

FIG. 3 shows in greater detail components of an infrastructure according to an embodiment of the present invention;

FIGS. 4A, 4B and 4C schematically depict an operations flow according to an embodiment of the present invention; and

FIG. 5 pictorially shows a scenario wherein an alternative embodiment of the invention is applied.

### DETAILED DESCRIPTION OF THE PREFERRED EMBODIMENT(S)

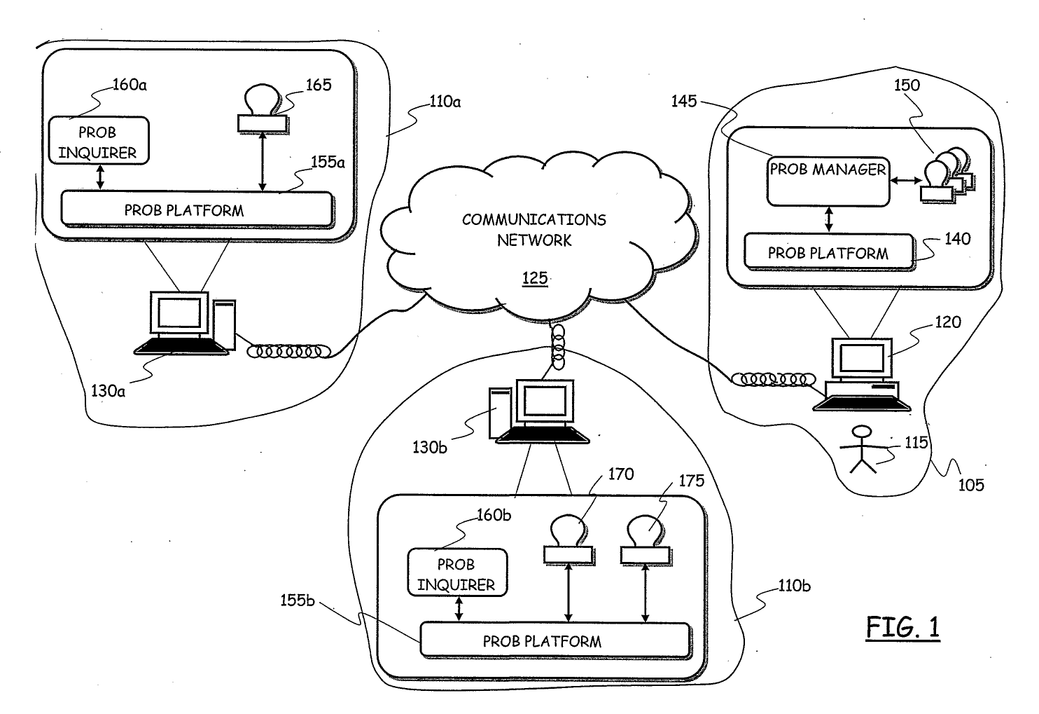

Referring to FIG. 1, a scenario wherein an embodiment of the present invention is applied is schematically depicted, including a sensitive information supplier domain 105 and a first and second information consumer domains 110a and 110b.

For the purposes of the present description, the information supplier domain is intended to represent the set of HardWare (HW) and SoftWare (SW) resources of a user, acting as an information supplier 115 in the context of the present description, in particular HW and SW resources for acquiring, maintaining and trading digitized sensitive information of the information supplier 115. Similarly, the information consumer domains 110a and 110b are intended to represent the set of HW and SW resources of a first and second information consumers, in particular HW and SW resources for acquiring, maintaining and exploiting digitized sensitive information provided by information suppliers like the information supplier 115. Just by way of example, the information consumer domain 110a may represent an on-line bookshop service, for the on-line purchasing of books and similar publications; the information consumer domain 110b may represent an on-line banking service offered by a bank institute.

In particular, the information supplier domain 105 includes a data processing apparatus 120 like for example a personal computer, a portable computer, a pocket computer, a personal digital assistant, a smart phone or the equivalent, which is wired or wirelessly connected or connectable to a data communications network 125, for example the Internet (network access points for accessing the data communications network are not shown, for simplicity).

Similarly, the first and second information consumer domains include respective data processing apparatuses 130a and 130b, both wired or wirelessly connected/connectable to the data communications network 125.

For example, the information consumer domains 110a and 110b include Internet servers adapted to provide on-line accessible services to customers, like the information supplier 115, and, in order to provide the services in a personalized way, need to have personal information about the customers.

It is pointed out that the consideration of one information supplier and two information consumers is merely exemplary: the present invention applies as well in case of only one information consumer and plural information suppliers, or of a plurality of information consumers and of information suppliers.

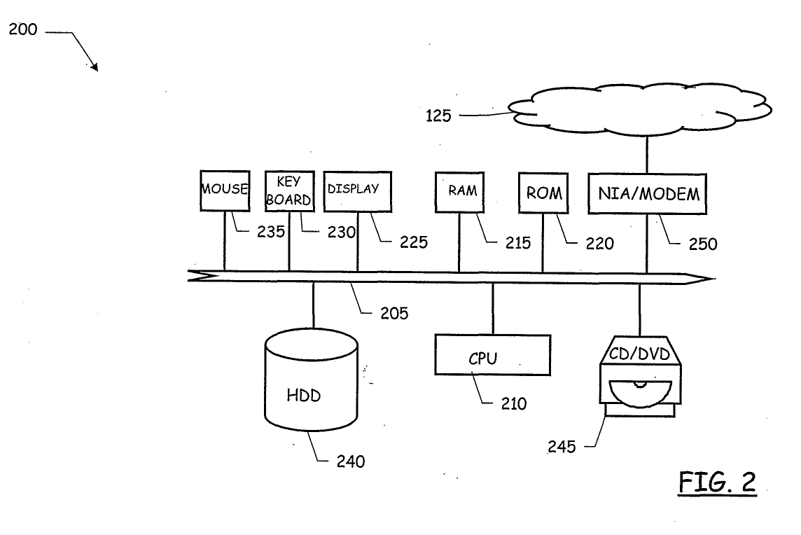

FIG. 2 schematically shows the main functional blocks of a generic data processing apparatus (hereinafter, shortly, computer) 200, like one of the data processing apparatuses 120, 130a and 130b. Several functional units are connected in parallel to a data communication (e.g., a PCI) bus 205. In particular, a Central Processing Unit (CPU) 210, typically comprising a microprocessor (possibly, a plurality of cooperating microprocessors), controls the operation of the computer, a working memory 215, typically a RAM (Random Access Memory) is directly exploited by the CPU 210 for the execution of programs and for the temporary storage of data during program execution, and a Read Only Memory (ROM) 220 is used for the non-volatile storage of data, and stores for example a basic program for the bootstrap of the computer, as well as other data. The computer 200 comprises several peripheral units, connected to the bus 205 by means of respective interfaces. Particularly, peripheral units that allow the interaction with a human user are provided, such as a display device 225 (for example a CRT, an LCD or a plasma monitor), a keyboard 230 and a pointing device 235 (for example a mouse). The computer 200 also includes peripheral units for local mass-storage of programs (operating system, application programs) and data, such as one or more magnetic Hard-Disk Drivers (HDD), globally indicated as 240, driving magnetic hard disks, a CD-ROM/DVD driver 245, or a CD-ROM/DVD juke-box, for reading/writing CD-ROMs/DVDs. Other peripheral units may be present, such as a floppy-disk driver for reading/writing floppy disks, a memory card reader for reading/writing memory cards, a Universal Serial Bus (USB) adapter with one or more USB ports, printers and the like. For the connection to the data communications network 125, the computer 200 may be further equipped with a Network Interface Adapter (NIA) card 250; alternatively (or in addition), the computer 200 may be connected to the data communications network 125 by means of a MODEM, not explicitly depicted in the drawing. In the case of a smart mobile phone, a radio communications interface is provided, intended to include all the HW and SW components necessary for enabling the mobile phone access a mobile telephony network, e.g. a GSM or UMTS network.

According to an embodiment of the present invention, digitized sensitive information about the information supplier 115 is distributed in the form of one or more SW objects, hereinafter also referred to as PROBs (acronym for Protective Responsive OBjects), e.g. SW agents, adapted to emulate human behavior in information trading, so as to extend to automated processing of digitized sensitive information the interaction pattern that normally applies when face-to-face negotiation between a human information supplier and a (human) information consumer takes place. In particular, in an embodiment of the present invention, the PROBs are adapted to be disseminated by the information supplier and to be installed in the information consumer domains.

In particular, in an embodiment of the present invention, a PROB is intended to be a SW component (i.e., a piece of SW) having at least all of the properties outlined below:
a PROB is a “container” object: it includes digitized sensitive information to be protected, in a suitable format;
a PROB is an “active” object: it includes executable computer program code adapted to at least process said digitized sensitive information;
a PROB is a “responsive” object: it provides at least one communications interface with other SW modules, by means of which said other SW modules can request the PROB to perform certain operations related to said protected digitized sensitive information and receive results of said processing;
a PROB is a “secure” object: it implements techniques adapted to prevent unauthorized extraction of said protected digitized sensitive information out the PROB itself.

In an embodiment of the present invention, PROBs are “assisted” objects: they are designed to be adapted to operate in an SW environment supporting PROB operations, controlling the PROB lifecycle and providing means for the PROBs to connect to other SW modules and interact with them in a secure manner.

In particular, in an embodiment of the present invention, a distributed SW environment is provided, adapted to support the exchange of digitized sensitive information between the information supplier and the information consumers, through the PROBs. In particular, the distributed SW environment according to the exemplary invention embodiment considered herein includes a distributed SW platform, even more particularly a SW agent platform, hereinafter also referred to as the “PROB platform”, adapted to set up an execution and communication environment for the PROBs. It is observed that the concept of SW agent platform, setting up execution and communication environments for SW agents, is per-se known in the art. In particular, according to an embodiment of the present invention, the PROB platform is adapted to ensure that it is not too easily tampered with, for instance by exploiting code obfuscation, secure storage and other per-se known techniques for preventing reverse engineering and other similar hacking attacks. An example of a SW agent platform suitable to be used as a basis for implementing the PROB platform according to the herein described embodiment of the present invention is the JADE platform, described for example in http://jade.tilab.com/. Without entering into details known to those skilled in the art, the JADE (Java Agent DEvelopment Framework) is a software framework fully implemented in Java language that simplifies the implementation of multi-agent systems through a middle-ware that complies with the FIPA (Foundation for Intelligent Physical Agents, a standards organization for agents and multi-agent systems, fully described at http://www.fipa.org/) specifications and through a set of graphical tools that supports the debugging and deployment phases. The agent platform can be distributed across machines (which do not need to share the same operating system) and the configuration can be controlled via a remote graphical user interface. The configuration can be even changed at run-time by moving agents from one machine to another one, as and when required.

According to an embodiment of the present invention, a distributed PROB platform component is installed on the data processing apparatus of each subject involved in the exchange of digitized sensitive information, in the shown example the information supplier 105 and the two information consumers 110a, 100b. The programs are for example installed on the hard disks of the data processing apparatuses, e.g. from CD-ROM or DVD supports, or downloaded from a SW distribution center via the data communications network 125, and, when launched, are at least partly loaded into the working memory of the data processing apparatuses.

The PROB platform enables creation, termination, installation, execution and discovery of PROBs, as well as digital license enforcement and establishment of secure communications channels between PROBs and other SW modules, as will be described in greater detail later.

In particular, an instance 140 of the distributed PROB platform runs in the data processing apparatus of the information supplier domain, particularly in the working memory 215 of the computer 120.

A PROB manager module 145 is executed on top of the distributed PROB platform instance 140; the PROB manager module 145 is adapted to enable the information supplier 115 to create one or more PROBs, manage a local collection of PROBs 150, and selectively distribute the PROBs to the information consumers.

In particular, the PROB manager module 145 is adapted to manage the creation, by the information supplier 115, of PROBs to be provided to information consumers, and to fill the PROBs being created with selected (possibly all) digitized sensitive information elements, suitable to optimize specific transactions to be automatically carried out on behalf of the information supplier with the information consumers; the PROB manager module 145 is also adapted to manage the distribution of the created PROBs to the information consumers.

The PROB platform instance 140 and the PROB manager module 145 form, or are part of, an information supplier PROB platform.

According to an embodiment of the present invention, the PROBs to be distributed to the information consumers are protected in order to make it impossible, or at least impractical, for third parties different from the intended information consumers to exploit them. In particular, according to an embodiment of the present invention, the protection of the PROBs is achieved by encrypting their executable code.

More specifically, according to an embodiment of the present invention, the PROD executable code is encrypted using a symmetrical encryption key. The PROB manager module 145 is further adapted to create digital licenses, which include the symmetrical encryption key needed to decrypt the encrypted PROB executable code so as to render the PROB usable. The digital licenses are associated and distributed together with the PROBs to the information consumers, so as to enable only intended information consumers to access and use the PROBs and the information included therein.

The digital licenses preferably also include PROB usage rules adapted to set limits of usage of the PROBs by the information consumers; for example, the PROD usage rules may specify the right to perform inquiries on the PROB only for a limited number of times, or for a limited time period. By way of example, the digital licenses needed to access and use the PROBs may be issued by the information supplier owning the PROBs against some form of direct or indirect remuneration.

Preferably, in order to prevent misuse (e.g., duplication or distribution) of the digital licenses needed to use the PROBs, the digital licenses issued to an information consumer are protected, for example by means of an asymmetric encryption mechanism encrypting the digital licenses with a public encryption key of the intended information consumer, so that only the intended information consumer can decrypt the digital licenses, using its private encryption key, and get the symmetric encryption key necessary to decrypt and use the PROB.

Preferably, the PROB manager module 145 is further adapted to keep track of the distributed PROBs and digital licenses.

The distributed PROBs may be further adapted to generate and send to the PROB manager module 145 usage reports, and the PROB manager module 145 may be further adapted to revoke the distributed PROBs in case they appear to be compromised.

Furthermore, the PROB manager module 145 may be adapted to interact with the distributed PROBs, in order to explicitly authorize or prohibit specific PROB actions.

In the domain of the generic information consumer, like the information consumer domains 110a and 110b, a respective instance 155a and 155b of the distributed PROB platform runs in the data processing apparatus 130a and 130b of the information supplier domain 110a and 110b.

A PROB inquirer module 160a and 160b is executed on top of the distributed PROB platform instance 155a and 155b, and is adapted to interact, through the PROB platform instance 155a and 155b, with one or more resident PROBs, like the PROB 165 resident in the information supplier domain 110a, and the PROBs 170 and 175 resident in the information supplier domain 110b. In the example herein discussed, the PROBs 165, 170 and 175 are considered to be all PROBs of the information supplier 115, specifically created for different types of transactions with the information consumers 110a and 110b; however, in general, one or more PROBs of different information suppliers can be resident in the domain of the generic information consumer, and the PROB inquirer module is able to interact with all of them, through the PROB platform. Referring to the above example of on-line bookshop service and on-line banking service, the PROB 165 is adapted to impersonate the information supplier 115 in the evaluation of proposals of books purchases, filtering them according to the information suppliers preferences; the PROBs 170 and 175 are adapted to impersonate the information supplier 115 before the bank, for example to evaluate investments proposed by the on-line banking service, based on the knowledge of the financial assets, investing attitudes, risk acceptance and the like, and/or to authorize expenditures based on the knowledge of the current credit on the user bank account.

The PROB platform instance 155a, 155b, and the PROB inquirer module 160a, 160b form or are part of an information consumer PROB infrastructure.

More specifically, the PROB inquirer modules 160a and 160b are adapted to perform queries on the desired PROB, and to receive responses therefrom.

In order to access the desired PROB, the PROB inquirer modules 160a and 160b are adapted to provide to the PROB platform instances 155a and 155b the necessary digital license, received from the PROB manager module 145 in the information supplier domain 105.

The generic PROB, like the PROBs 165, 170 and 175, is adapted to receive (via the PROB platform) queries from the PROB inquirer module 160a and 160b running in the information consumer domain wherein the PROB resides, process the queries, and respond (via the PROB platform) to the information inquirer module. Additionally, the generic PROB may be adapted to communicate (via the PROB platform, and the communications network 125) with the PROB manager module 145 running in the domain 105 of the information owner 115, so as to send usage reports, for example reporting the PROB manager module the queries received from the PROB inquirer module, and the responses provided thereto; also, the PROB may ask the PROB manager 145 an explicit authorization to respond to specific queries from the PROB inquirer module.

Preferably, in order to increase flexibility, a PROB resident in the generic information consumer domain, like any one of the PROBs 165, 170 and 175, is adapted to contact other PROBs of the information supplier 115 so as to get missing information elements necessary for responding to a query from the PROB inquirer module. In particular, according to an embodiment of the present invention, the generic PROB is adapted to contact the PROB manager 145 in the information supplier domain 105 in order to discover other PROBs of the information supplier 115, for getting additional information elements useful to carry out a transaction. For example, in case the PROB 165 needs additional information elements for responding to a query from the PROB inquirer module 160a, the PROB 165 is adapted to ask the PROB manager module 145 if another PROB exists holding the necessary piece of information, and the PROB manager module 145, once identified the proper PROB, like for example the PROB 170, is adapted to provide to the PROB 165 the directives for contacting the PROB 170.

The PROB platform instances running in the information supplier and information consumer domains may be functionally equivalent, in that they may provide the same services to the components making use of them, like the PROB manager modules, the PROB inquirer modules and the PROBs. It is observed that while the PROBs run exclusively on top of the PROB platform running in the information consumer domain, and rely on the PROB platform for all of their communications needs, other components like the PROB manager module and/or the PROB inquirer module may also use services provided by other SW applications running in the respective domain, particularly other SW platforms, like for example specific data processing or communications platforms needed to acquire, maintain or exploit information, as well as networking facilities to transfer the PROBs and associated digital licenses.

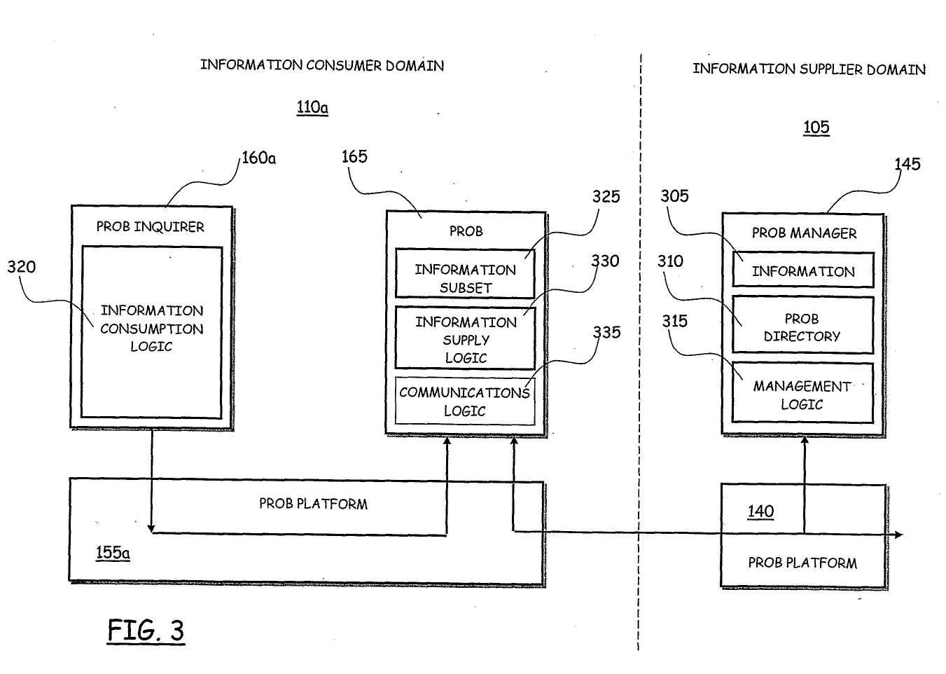

FIG. 3 schematically depicts, in greater detail, the structure of the PROB manager module, of the generic PROB inquirer module, and of a generic PROB, in an embodiment of the present invention; only the information supplier domain 105 and the information consumer domain 110a are considered, for the sake of simplicity.

The PROB Manager module 145, running in the data processing apparatus of the information supplier, includes a database where it can have access to a collection 305 of information elements regarding the information supplier 115, who can be either an individual or an organization. The information collection 305 includes in particular digitized sensitive information, expressed in textual form.

The PROB manager module 145 keeps and manages a PROB directory 310, describing all the PROBs created by the PROB manager module; in particular, for each created PROB, a description is provided adapted to at least allowing to determine what subset of the information elements, among all those included in the collection 305, are contained in the PROB, and directives as to how to contact the PROB (e.g., an URL—Universal Resource Locator or IP address of the Internet site of the information consumer domain wherein the PROB is resident).

The PROB manager module 145 further includes a management logic 315 adapted at least to create and deliver PROBs to information consumers in accordance with a predetermined information trading strategy. For instance, and with reference to the previous example scenario, the management logic 315 may be instructed to automatically contact an on-line bookshop and decide to deliver a PROB thereto in exchange, for example, of a special discount on new publications or the possibility for the PROB to be alerted whenever promotional sales take place. The management logic 315 may be represented by a SW program running on the information supplier data processing apparatus 120 (FIG. 1), adapted to create PROBs to be provided to information consumers, including an optimized subset of information elements out of the collection 305, wherein said optimized subset may include the minimum amount of information deemed necessary for satisfying the needs of the specific information consumer.

For example, the management logic 315 may include a component similar to the flying profile manager module described in the already cited document WO 2004/077784, adapted to select, from the collection 305 of sensitive information, the subset of information elements from time to time sufficient to perform a certain transaction with an information consumer.

For example, in case the information supplier 115 is a person who is looking for a job, the management logic 315 may be used to create one PROB-per potential employer. The management logic 315 inserts in each PROB a more or less rich subset of information elements out of the collection 305, according to what the information supplier 155, or, possibly, the management logic 315 in a default manner, deems necessary to respond to an employer's queries.

The management logic 315 is also preferably adapted to terminate and revoke the PROBs delivered to the information consumers, for example upon expiry of a predetermined or user-defined time period.

The generic PROB inquirer module, like the PROB inquirer module 160a, is a SW module running on the data processing apparatus of an information consumer and including at least an information consumption logic 320 adapted to at least generate PROB queries to be addressed to (one of) the PROB(s) residing in the information consumer domain, and to process query responses from the PROB(s), in accordance with a predetermined business logic; for example, in case the information consumer is a bank, the information consumption logic 320 may interact with the conventional modules of a data processing system of the bank so as to act as an interface towards the PROB, and it is in particular adapted to retrieve the information elements from the PROB responses and make them available to the other modules, which use the customer information in order to perform account operations or manage customer relationships.

The generic PROB, like the PROB 165 shown in the drawing, includes an information elements subset 325, consisting in a subset of the information elements contained in the collection 305, particularly the subset of information elements that the management logic 315 of the PROB manager 145 embedded in the PROB at the time of its creation.

The PROB further includes an information supply logic 330, adapted to at least processing queries to the PROB received from the PROB inquirer module and, using the information elements in the information elements subset 325, to generate PROB responses, in accordance with a logic that depends on the characteristics of information elements subset 325; for example, in case the information elements subset 325 includes information elements adapted to describe customer's preferences concerning books, the information supply logic 330 may be able to process news and respond to offers from an on-line bookshop. To these purposes, the information supply logic 330 may include in particular an expert system module (such as a knowledge-based system module), able to make predictions of what the human information supplier 115 would do in similar situations. Techniques to build effective expert systems based on dynamic user modeling algorithms are well known in the art. In particular, it is known that an efficient way of obtaining fairly reliable predictions of a user's behavior in a pre-determined context consists in producing a balanced mix of responses from multiple prediction algorithms, e.g. a first one exploiting a stereotypical classification of the user, a second one based on the accumulated knowledge about past user choices and a third one processing information provided straightly by the user on demand. Applicable user modeling algorithms like Bayesian Networks are documented in the literature.

The PROB also includes a communications logic 335 adapted to at least initiating communications sessions with the PROB manager module 145, and/or with other PROBs, resident in the same or in different information consumer domains (like the PROBs 170 and 175 shown in FIG. 1).

The generic PROB platform instance running in the data processing apparatus of the information supplier domain, like for example the PROB platform instance 140, is a SW module adapted to at least provide services of PROB protection and digital license protection. In particular, in an embodiment of the present invention, PROB protection is implemented by encryption of the PROB executable computer program code: the PROB platform instance 140 is in particular adapted to receive a PROB created by the PROB manager module 145, and to encrypt it using a symmetrical encryption algorithm, like the per-se known AES algorithm, generating a digital signature of the PROB executable computer program code. Additionally, the PROB platform 140 is adapted to protect digital licenses generated by the PROB manager and associated with the PROBs; according to an embodiment of the present invention, digital license protection is for example implemented by means of asymmetrieal encryption, e.g. using the per-se known RSA algorithm; to that end, the PROB platform may have access to a public key of the intended digital license recipient.

The generic PROB platform instance running in the data processing apparatus of the information consumer domain, like for example the PROB platform instance 155a or 155b, is a SW module adapted at least to provide PROB decryption, authentication and execution services. In particular, PROB authentication is implemented by verifying PROB code digital signature; execution of the PROB code is for example supported by means of Application Programming Interfaces (APIs) of a software application framework, like those provided by the JADE platform.

The PROB platform instances running at the information consumer domains are also adapted to enforce digital licenses; in particular, the PROB platforms are adapted to decrypt (using private encryption keys) digital licenses associated to the PROBs, store them in a secure repository and grant a PROB inquirer module the possibility to set up a communications channel with a PROB only if usage rules contained in said digital licenses allow so.

The PROB platforms are further adapted to enable communications among PROBs and other software modules, for example by means of APIs, allowing software modules, like the PROB manager module and the PROB inquirer module, running on top of the PROB platform, to set up possibly secure communications channels (like a Secure Socket Layer—SSL—connection), so as for example to convey PROB queries, responses, reports and other data.

It is observed that the specific query language used by the PROB inquirer modules to query the PROBs is not critical nor limitative to the present invention; in general, the chosen query language may depend on the specific information trading context. Any suitable formal language may be used, including for instance software agent interaction protocols like those defined by the FIPA (Foundation for Intelligent Physical Agents) consortium.

The queries that the PROB inquirer modules perform on the PROBs should not directly request user data, i.e. they should not try to directly access and extract the sensitive information, but rather require evaluation of proposals following a predefined negotiation pattern agreed in advance between the information supplier and the information consumer. For example, in an embodiment of the present invention a set of predefined possible negotiation patterns could be defined, adapted to cover some relevant business cases (e.g., bank transaction, job appliance, on-line purchase, and so on); every PROB may be created to support an initial query by means of which a PROB inquirer module can determine what specific negotiation pattern(s) that particular PROB is able to handle. For instance, with reference again to the on-line bookshop case, the shop's PROB inquirer should not ask a user PROB to fill in a sort of questionnaire stating the user's preferences as regards various book categories, but rather submit an initial book offering to the PROB. The initial offering might be quite broad in scope spanning several possible topics. The PROB does not need to explicitly evaluate all of the items included in the offering; it may instead, based on the offering content and knowledge of user tastes, ask the PROB inquirer for more information about specific titles of even on books covering topics non included in the initial submission. The PROB inquirer would then issue a revised offering in response to the PROB request, which would be in turn judged and replied to by the PROB and so on, up to a point where the iterative process yields to a refining of the initial book offering that is deemed by the user PROB suitable to make a decision close enough to user expectations. Of course both parties “learn” something of one another during the trading, but only to the extent that is strictly necessary to fulfill their respective goals.

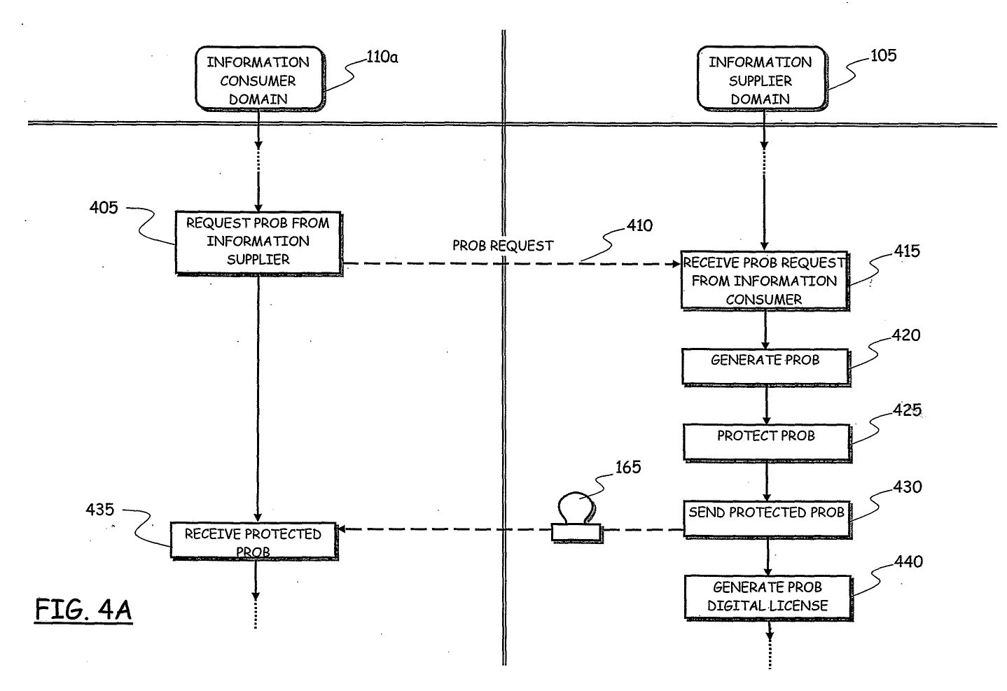

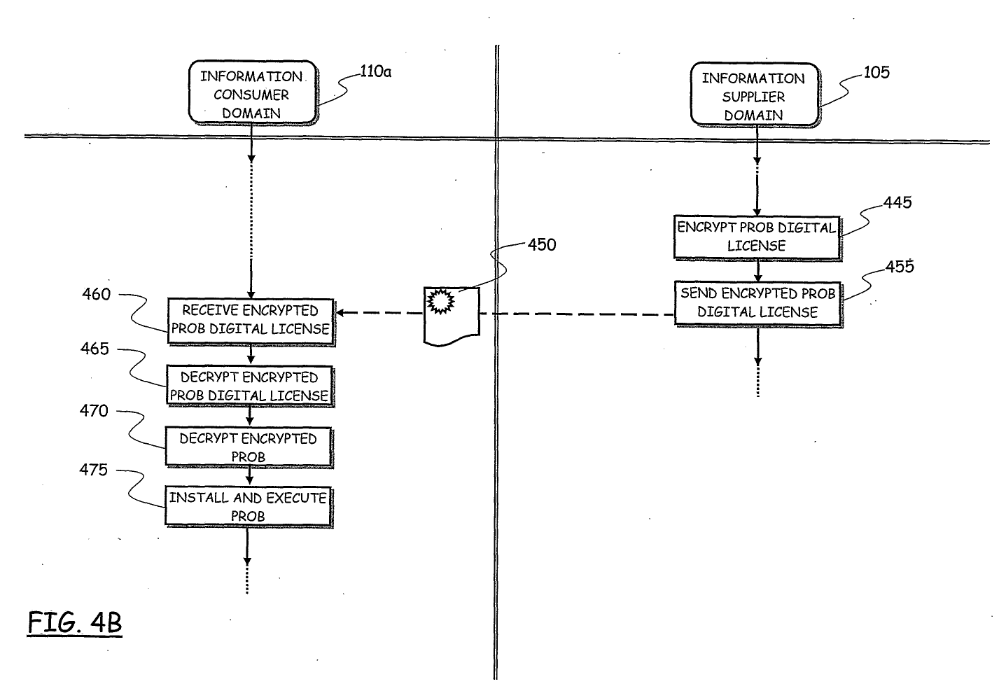

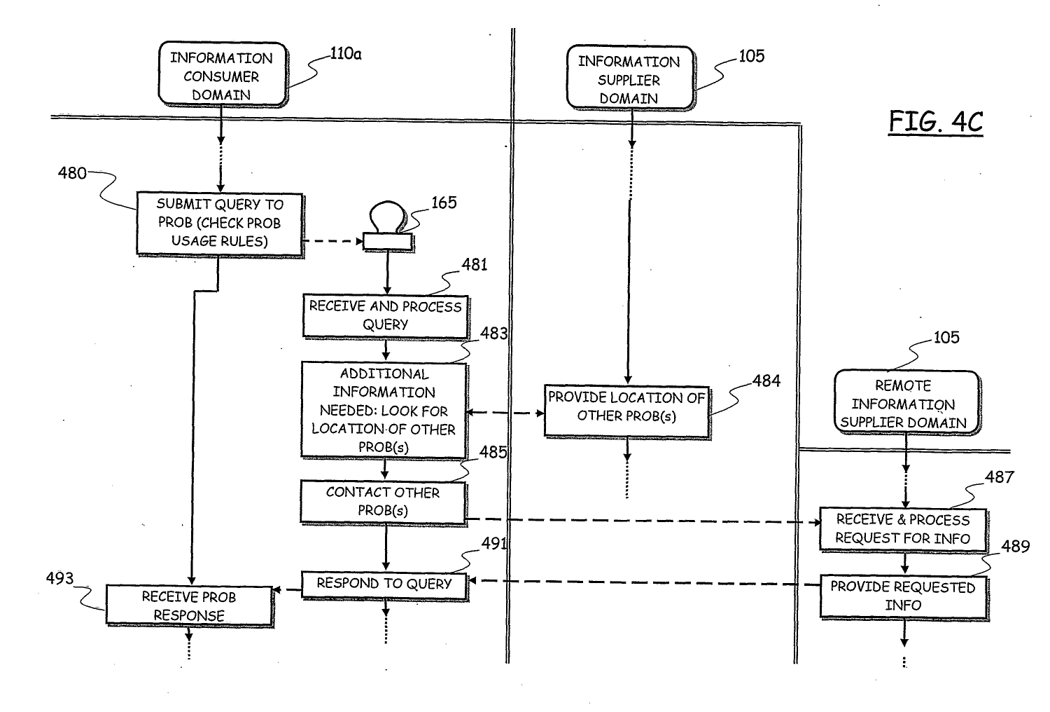

The operations of the elements described in the foregoing will be now described, in the context of a method according to an embodiment of the present invention, with the help of the schematic operation flow of FIGS. 4A, 4B and 4C.

As a preliminary phase, a provisioning of a PROB adapted to act on behalf of the information supplier 115 to one or more information consumer is needed. For example, and not limitatively, the components of the PROB infrastructure, for example the PROB inquirer module 160a in the domain of the information consumer, e.g. the information consumer domain 110a, may automatically send (block 405), over the data communications network 125, a PROB request (410) to the PROB infrastructure in the domain 105 of the information supplier.

For example, under the assumption that the information consumer is an on-line service provider providing on-line services to users, e.g. an on-line virtual bookshop, the sending of the PROB request may be triggered by the information supplier 115 visiting (using his/her data processing apparatus and a conventional web browser) the web site of the on-line bookshop; the on-line bookshop web site may request the information supplier 115 to register in order to be able to, e.g., purchase books on-line, and/or being kept informed of offers, new issues, and similar: if the user accepts to register, instead of the conventional request to fill-in an on-line form displayed to the information supplier 115 by his/her web browser, the PROB infrastructure of the on-line bookshop, e.g. the PROB inquirer module 160a is invoked, and instructed to send the PROB request 410.

The PROB request 410 is received by the PROB infrastructure in the information supplier domain 105 (block 415); for example, the PROB request 410 is received and handled by the PROB manager module 145.

Responsive to the PROB request 410, the PROB manager module 145 creates a new PROB (block 420). For the creation of the new PROB, the information supplier 115 may interact with the PROB manager module 145 so as, in particular, to select which of the information elements in the information elements collection 305 available to the PROB manager module to include in the new PROB.

In particular, the PROB manager module 145 may preliminary search in the PROB collection 150 to determine whether there is an already available PROB suitable for the purposes of satisfying the PROB request. In order to determine whether any one of the already available PROBs is suitable, the PROB descriptions in the PROB directory 310 are exploited, in particular the PROB manager module 145 may compare the information elements selected by the information supplier with the information elements subset contained in the already available PROBs.

In alternative, or as a further option, an automatic PROB creation functionality may be implemented, according to which the information supplier 115 may instruct the PROB manager module 145 to build the new PROB embedding therein a sufficient amount of information elements to interact with the information consumer in the intended manner. To this purpose, the management logic 315 may for example include a component similar to the flying profile manager module described in the already cited document WO 2004/077784, which, based on the request from the information supplier, is adapted to select, from the collection 305 of sensitive information, the subset of information elements from time to time sufficient to perform a certain transaction with an information consumer.

In a specific embodiment of the present invention, the PROB request may contain a description of the information consumer status and activities, the goals in view of which the user is required to release a PROB and the benefits for him/her in complying to the request; for instance, the virtual bookshop may inform the user that he/she will get reduced prices if he/she accepts her PROB to be periodically interviewed about new book issues as well as receiving customized offerings in accordance with her preferences. The information exchange in this phase is of a pretty commercial or contractual nature and need not be entirely automated, but in any case many types of formal languages can be devised based on existing business rules representation notations in order to univocally represent all concerned data within a specific PROB infrastructure implementation. Similarly, the exact algorithms by means of which a PROB manager selects the user information to be packed into the PROB may depend on the particular business environment, exploiting for example simple keyword matching mechanisms to pick up pre-defined information subsets corresponding to the available PROB types. Licenses can also be generated applying standard patterns or more sophisticated criteria, for example as the result of a negotiation between the information supplier and consumer where less strict licensing terms are traded for additional economic benefits for the user.

The PROB created by the PROB manager module 145 includes, as discussed in the foregoing, the information elements subset 325, the information supply logic 330, and the communications logic 335. In particular, the information elements subset 325 includes digitized sensitive information about the user supplier 115, for example book preferences and the payment method; the information supply logic 330, in the example at issue, is a logic adapted to process queries received from the PROB inquirer module 160a of the on-line bookshop PROB infrastructure, concerning for example offers of new books, and predicting user choices based on a specific user model.

Before being sent to the information consumer, the PROB is then protected (block 425). In particular, in an embodiment of the present invention the PROB manager module 145 requests to the PROB platform 140 to encrypt the PROB executable computer program code. The PROB platform may for example encrypt the PROB executable code using any known symmetric-key encryption algorithm like the AES, wherein the encryption key may be a randomly generated code, and digitally sign the PROB executable code.

The encrypted and digitally-signed executable code of the PROB 165 is then sent (block 430) to the PROB infrastructure of the information consumer; for example, the PROB manager module 145 may manage the sending of the protected PROB to the PROB inquirer module 160a, over the data communications network 125, for instance through an HTTP download session. The protected PROB is received by the PROB infrastructure (e.g., by the PROB inquirer module) of the information consumer (block 435), and locally stored.

Then, the PROB infrastructure of the information supplier generates a digital license to be associated with the PROB 165, and to be provided to the PROB infrastructure of the information consumer for enabling it using the PROB (block 440). In particular, in an embodiment of the present invention, the PROB manager module 145 requests the PROB platform 140 to generate the digital license to be associated with the PROB 165; the digital license contains in particular the encryption key used to encrypt the PROB executable code, and usage rules defining the way the PROB inquirer module may use the PROB; for example, a simple usage rule may set a limited usage time, e.g. one month.

The generated digital license is then encrypted (block 445), for example by the PROB platform 145, using for example an asymmetric encryption algorithm like the RSA algorithm, using a public encryption key of the information consumer; the public encryption key may for example have been provided by the PROB inquirer to the PROB manager during an initial authentication session of the user before the information consumer.

The information supplier PROB infrastructure, for example the PROB manager 145 then sends the encrypted digital license 450 to the information consumer PROB infrastructure (block 455) over the communications network 125, e.g. through an HTTP download session.

The encrypted digital license 450 is received (block 460) by the information consumer PROB infrastructure, for example by the PROB inquirer module 160a, which locally stores it.

It is observed that nothing prevents that encrypted and digitally signed PROB and associated digital license are sent together to the information consumer PROB platform, or that the digital license is generated and/or sent before the PROB.

The encrypted and digitally-signed executable code of the PROB 165 is passed to the PROB platform 155a for installation in the information consumer PROB infrastructure; similarly, the encrypted digital license 450 is passed to the PROB platform 155a, for its enforcement.

The PROB platform 155a decrypts the encrypted digital license (block 465), using the private encryption key of the information consumer. Using the symmetric encryption key included in the decrypted digital license, the PROB platform 155a decrypts the encrypted PROB executable code (block 470). The PROB platform 155a then installs the PROB 165 and launches it (block 475).

At a subsequent time, the information consumer may need to get information from the PROB 165; for example, this may happen when a new book is published and enters the catalogue of the on-line bookshop, and the on-line bookshop service wishes to inform the information supplier 115 of this event.

The PROB inquirer module 160a submits a query to the PROB 165 of the information consumer 115 to get the necessary information about the information supplier 115.

In particular, the query is submitted through the PROB platform 155a. The PROB platform 155a checks whether the query complies with the usage rule(s) specified in the digital license associated with the PROB (referring to the above example, the PROB platform checks whether the one-month usage period has already expired), and, in the affirmative case, the query is submitted to the PROB 165 (block 480), otherwise the PROB platform 155a blocks the query and notifies the PROB inquirer module 160a, informing it that, for example, the right to communicate with the PROB is expired.

The PROB 165 receives the query and processes it (block 481). In particular, the query is processed by the information supply logic 330 using the information elements included in the subset 325. Referring again to the on-line bookshop example, the query issued by the PROB inquirer module may ask for the information supplier interest in a newly published book that can possibly be purchased on-line at special conditions within a certain time frame. The information supply logic 330 may check and evaluate the offer in view of the information supplier preferences and habits (information available; in the information elements subset 325, but not directly accessible by the PROB inquirer module), and make a decision on whether to accept or deny the offer.

As a result of the query processing, the information supply logic 330 may issue a response for the PROB inquirer module 155a; alternatively, or in particular circumstances, the information supply logic 330, before issuing a response to the PROB inquirer module 155a, may communicate with the PROB manager module 145 in the PROB infrastructure of the information supplier 115; for example, the information supply logic 330 may ask for an explicit authorization from the PROB manager module 145 for responding to the query, for example for authorize a transaction, or simply report the PROB manager module about the ongoing transaction with the PROB infrastructure of the information consumer, so that the PROB manager module can build a log that can then be consulted, if desired, by the information supplier. For example, the information supplier 115 may be alerted of the ongoing transaction through a graphical user interface on his/her data processing apparatus; the user may then authorize the transaction and approve the related payment.

Communications of the PROB 165 with the information supplier PROB infrastructure are managed by the communications logic 335, and pass through the PROB platform instances 155a and 140. Details needed to contact the PROB manager module 145, like for example an IP address of the data processing apparatus 120 of the information supplier, or an e-mail account thereof, are for example embedded in the communications logic 335 of the PROB 165.

Also, in some cases the information supply logic 330 may determine that, in order to respond to the query from the PROB inquirer module 160a, additional information elements are needed (block 483); for example, in order to make a decision about whether or not to accept a purchase offer, the information supply logic 330 may have to ascertain the ability of the information supplier to pay a certain amount of money.

In such cases (as schematically depicted in the drawing), the information supply logic 330 of the PROB 165 may contact the PROB manager module 145, for example through a secure communications channel, like an SSL connection (established by the communications logic 335), and (directly or through the PROB manager module) browse in the PROB directory 310, looking through the PROB descriptions, so as to determine which is the PROB adapted to provide the additional information needed; once the proper PROB has been identified, the location thereof, e.g. the IP address of the data processing apparatus of the information consumer domain wherein the PROB is installed, is retrieved (block 484).

For example, let it be assumed that the information consumer 110b represents a bank whereat the information supplier 115 has an account, and that the PROB 170 is used by the PROB platform of the bank for performing transactions on behalf of the information supplier; in particular, the PROB 170 includes a collection of information elements and an information supply logic adapted to make decisions about money transactions in view of the current credit of the user and a pre-determined policy.

The information supply logic 330 of the PROB 165 may thus contact (through the communications logic 335) the remote PROB 170 (block 485) and ask for the additional information, e.g. the confirmation of the user ability to pay the specified amount of money. The PROB 170 receives and processes the request for additional information (block 487), and in reply provides the requested information to the PROB 165 (block 489). Preferably, the communications between the PROBs 165 and 170 take place through a secure channel, like an SSL connection, handled by the communications logics 335 of the PROBs.

Once the information supply logic 330 of the PROB 165 has the necessary information, it generates a response for the PROB inquirer (block 491). The PROB response passes through the PROB platform 155a and is routed to the PROB inquirer module (block 493). Based on the received response, the PROB inquirer module informs other application SW modules in the information consumer domain 110a, which for example start an internal procedure for the shipping of the purchased book, and for correspondingly debiting the user's bank account. For example, the response from the PROB may contain for instance an authorization, digitally signed on behalf of the user, which the on-line bookshop can forward to a bank to order a money transfer from the user account: in such a case, the information supplier gives no personal information at all when registering at the on-line bookshop, not even a credit card number or other paying credentials: he/she just provides the on-line bookshop with his/her PROB, acting on behalf thereof and representing him/her also as concerns service-related financial transactions.

The information consumer may also implement an implicit modeling system that, based on the responses from the PROB, is adapted to build a model of the information supplier, inferring from the PROB responses the user's profile, in order to be able to submit offers which try to be close to the user interests. However, it can be appreciated that even in this case, thanks to the impersonation of the information supplier by the PROB, the information got by modeling system is no more than that would be acquired through direct interaction with the user.

It is pointed out that the sequence of steps described above is merely an example of a possible interaction pattern among the components of the PROB infrastructure, and that alternative interaction patterns can be conceived, depending in particular on the specific information trading model that is to be implemented; the present invention is however not limited to any specific information trading model.

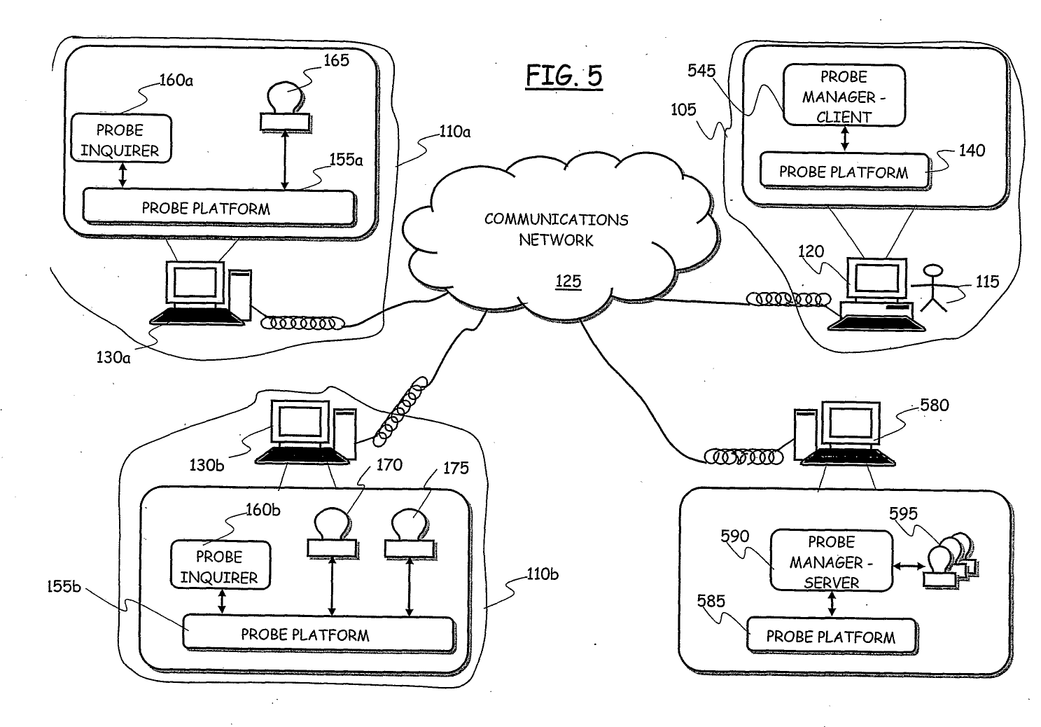

FIG. 5 depicts, in a way similar to FIG. 1, an alternative embodiment of the present invention. In particular, in the alternative invention embodiment shown, the interaction between the information consumers and the information supplier(s) is not direct as in the former embodiment, being instead mediated by a third party, for example a server 580 that provides a centralized service of creation, distribution and management of the life cycle of the PROBs for different information suppliers like the information supplier 115. In the information supplier domain, a client PROB manager module 545 is executed on top of the PROB platform 140. The client PROB manager module 545 interacts with a server PROB manager module 590 running on the server 580 on top of a PROB platform instance 585. The server PROB manager module 590 performs functions similar to those performed by the PROB manager module 145 of the former embodiment, but in a centralized way for all the information suppliers; the information suppliers interact and direct the operation of the server PROB manager module 590 through the client PROB manager modules 545 running in their local data processing apparatuses 120.

An advantage of the present invention, that allows persistent protection of digitized sensitive information even after distribution to the intended information consumers, is that even the intended information consumer has no direct access to information embedded into the PROBs: it can only place queries and infer part of the sensitive information from PROB responses to the queries. Referring again to the exemplary operation flow described above, the information supplier needs to provide the information consumers, e.g. the on-line bookshop, with very little or no personal information; he/she does not have, for example, to release detailed personal information filling in a questionnaire and, on the other hand, no practical questionnaire could be so analytical to convey all the user information that can be embedded into a PROB (e.g. including a predictive model of the user behavior).

Another advantage of the herein disclosed method is that the PROBs, which are the entities carrying with them the digitized sensitive information, always travel between an information supplier and an information consumer as protected, e.g. encrypted objects. With reference to the exemplary operation flow described in the foregoing, even though a third party intercepted the PROB executable code while it is being delivered from the PROB manager module of the information supplier PROB infrastructure to the PROB inquirer module of the information consumer PROB infrastructure, such third party would not be able to run the PROB executable code as long as it remains encrypted. If said third party also intercepted the digital license associated with the PROB while it is being transferred, he/she would still not be able to extract the PROB code decryption key, because the digital license has in turn been encrypted with the public key of the intended information consumer, e.g. the on-line bookshop, in such a way that only the intended information consumer owning the corresponding private key can decrypt it. Thus, according to the present invention, PROB executable code and digital licenses never travel in “clear text” form, and are put in clear text form only when installed into an information consumer PROB infrastructure, which is a secure, tamper-resistant software environment.

Although the present invention has been disclosed and described by way of an embodiment, it is apparent to those skilled in the art that several modifications to the described embodiment, as well as other embodiments of the present invention are possible without departing from the scope thereof as defined in the appended claims.

For example, the PROBs, instead of being located in the information consumer domains, i.e. where the information is consumed, might be retained in the information supplier domain: when a transaction in which personal information about the information supplier involved has to be carried out, the PROB inquirer module of the information consumer PROB infrastructure may remotely make queries to the PROB in the information supplier domain. The information supplier may however have to keep his/her data processing apparatus and PROB infrastructure always running, so to be ready to respond to requests from the information consumers, and ensure that it can always sustain the traffic rates implied by concurrently serving multiple information consumers. Communications between the information supplier and the information consumers will in this case take place over secure connections.

1-18. (canceled)

19. A method of protecting sensitive information in an information exchange between a first data processing system suitable to supply sensitive information and a second data processing system suitable to use sensitive information, comprising:
selecting in said first data processing system a sub-set of sensitive information elements from a collection of digital sensitive information elements;
storing the selected sub-set of sensitive information elements in a responsive software agent suitable to automatically react to information queries;
submitting said responsive software agent to an information query generated by said second data processing system; and
reacting to said information query by said software agent based on said sub-set of sensitive information.

20. The method of claim 19, further comprising:
generating said software agent in said first data processing system.

21. The method of claim 20, wherein the step of submitting is performed in the first data processing system and is preceded by the step of:
sending said query from said second data processing system to said first data processing system.

22. The method of claim 20, wherein the step of submitting is performed in the second data processing system and is preceded by the step of:
transferring said software agent from said first to said second data processing system.

23. The method of claim 22, wherein said software agent is transmitted over a data communication network.

24. The method of claim 22, wherein transferring said software agent comprises protecting the software agent from unauthorized access to said subset of sensitive information.

25. The method of claim 24, wherein protecting comprises:
encrypting said software agent; and
providing said second data processing system with a decryption key for decrypting the software agent.

26. The method of claim 25, wherein the decryption key is a symmetric encryption/decryption key.

27. The method of claim 26, wherein providing said second data processing system with a decryption key comprises:
encrypting the symmetric decryption key with a public encryption key of the second data processing system; and
transferring the encrypted symmetric decryption key to the second data processing system over said data communication network.

28. The method of claim 27, further comprising:
generating a digital license comprising usage rules of said sub-set of sensitive information, in said first data processing system.

29. The method of claim 28, further comprising:
sending said digital license from said first to said second data processing system.

30. The method of claim 28, wherein said digital license comprises the symmetric encryption/decryption key and further comprises:
encrypting the digital license with the public encryption key of the information consumer.

31. The method of claim 30, further comprising:
receiving the encrypted digital license at the second data processing system;
decrypting the encrypted digital license to extract the symmetric encryption/decryption key;
decrypting the software agent; and
installing the software agent in the second data processing system.

32. The method of claim 28, wherein said usage rules comprise a usage time limit.

33. The method of claim 19, further comprising:
after submitting said responsive software agent to an information query, requesting additional information from said software agent to a further software agent.

34. The method of claim 19, further comprising:
after submitting said responsive software agent to an information query, requesting additional information from said software agent to said first data processing system.

35. The method of claim 19, wherein reacting to said information query comprises responding to said information query based on said sub-set of sensitive information.

36. The method of claim 33, wherein reacting to said information query comprises responding to said information query based on said additional information.
